(19) United States
(12) Patent Application Publication
(10) Pub. No.: US 2008/0040128 A1
(43) Pub. Date: Feb. 14, 2008

(54) System for sales, distribution, and copyright protection of architectural drawings

(76) Inventor: Roy Lee Shafer, Lexington, VA (US)

Correspondence Address: Roy L. SHAFER, PO BOX 500, LEXINGTON, VA, 24450-0500, US

(21) Appl. No.: 11/472,647

(22) Filed: Aug. 10, 2006

(51) Int. Cl. G06Q 10/00; G06Q 30/00

(52) U.S. Cl. 705/1

(57) ABSTRACT

The system for sales, distribution, and copyright protection of architectural drawings is a proof of purchase based, copyright enforcement system, which can be verified during the application for a building permit. This makes it possible to sell home plans as merchandise, directly to a shopper. Home plans, offered in permit-ready format, carry a disclaimer which voids their applicability without a voucher. The voucher is separate from the actual drawings, and may appear in any form, such as a ticket or certificate, but for descriptive purposes, shall be described here as a dated receipt. The shopper makes his purchase, and is given a dated receipt. This receipt must be presented to the building official when applying for a building permit. Although this system does not guarantee building approval, it operates as a checkpoint during the process. If drawings are not accompanied by the required receipt, the drawings are rendered null and void, and the permit application does not continue. If no receipt is presented, it may indicate that the drawings have been copied or stolen. If the date has expired, it may indicate that the original drawings have been modified, resold, or there is an attempt to build multiple structures from the single plan purchase. This proof of purchase voucher system replaces current methods of copyright protection, which are difficult to enforce.

### REFERENCES CITED

| Patent Document No. | Inventor |
|---|---|
| US 2004/0074173 A1 | Miller |
| 1,379,867 | Johnson |
| 2,227,892 | Soldan |
| 2,753,237 | Wood |
| 2,871,080 | Shelly |
| 3,321,259 | Fiterman, et al. |
| 3,986,756 | Kranich |
| 4,433,883 | Boender, et al. |
| 5,031,214 | Dziewit, et al. |
| 5,191,613 | Graziano, et al. |
| Foreign Patent Doc. No. | Country & Date |
| 2001-331553 | Japan, November 2001 |

### BACKGROUND

Stock home plans are architectural designs of houses, made available by mail order. Magazines and internet sites offer construction-ready plans, complete with copyright protection disclaimers printed on the drawings. Purchasers are warned of legal action resulting from various infringements. However, such protection is difficult to enforce.

### SUMMARY

The system for sales, distribution, and copyright protection of architectural drawings provides an alternative method of copyright protection, making it possible to sell home plans as merchandise, directly to a shopper. Removing rubber stamped disclaimers or official seals from the drawings makes copyright protection a separate entity. This provides a secure tracking method, and reduces violations. Home plans will, however, make reference to the voucher requirement. For example, a statement such as “Dated receipt required. Void after 30 days from date of receipt” will appear in the title block of the home plan.

### IN THE ENCLOSED ILLUSTRATIONS

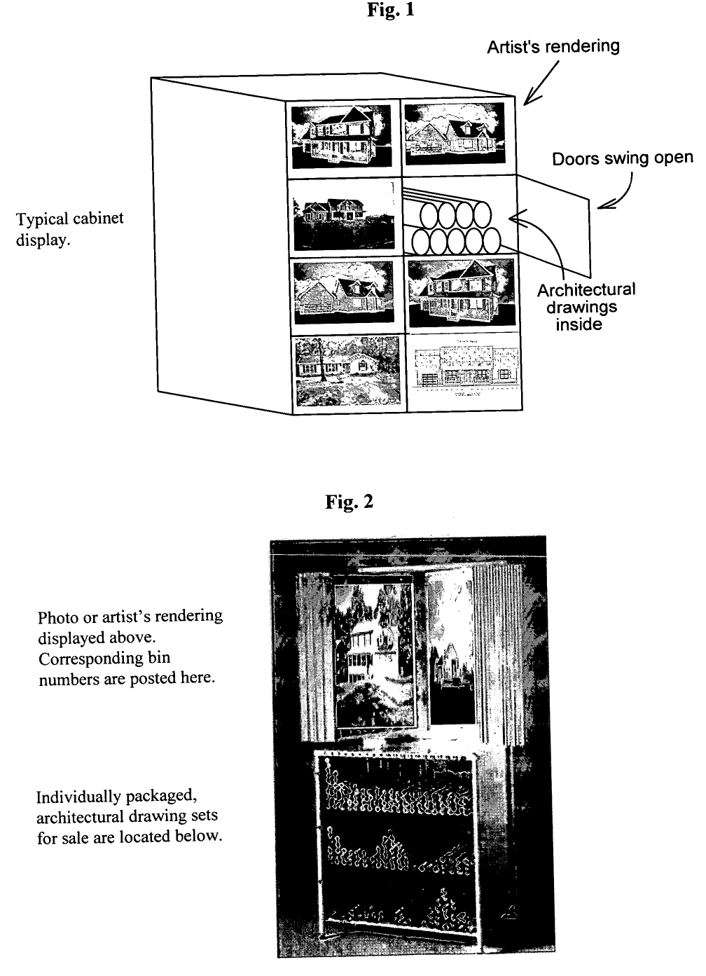

FIG. 1 represents a cabinet-style display cabinet, showing the individual cubby-holes which portray an artistic rendering or photo of a house on the exterior of the door, and a storehouse of corresponding plans inside.

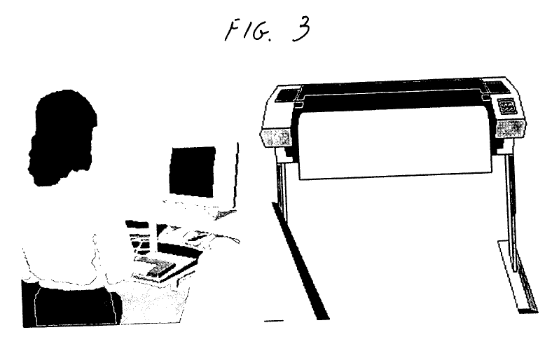

FIG. 2 shows a typical poster display unit with the artist's renderings displayed in flip-book fashion above the drawing storage bin. Reference numbers correspond to the renderings.

FIG. 3. represents a computerized system which allows the customer to choose a plan from a database, and print the drawings through self-serve or customer assistance.

All drawings are sold individually. Typically eight sets are distributed during the building process, but a customer may choose to buy a single set for study, or to take to an architect or designer for customization. The original designer is automatically released from liability, since the proof of purchase voucher only relates to the original drawing. Building multiple structures is not possible without purchasing additional plans and obtaining a voucher.

Avoiding the need to stamp the actual drawings allows the direct print and purchase system as shown in FIG. 3. It also makes inventory restocking quick and easy for the retailer or distributor, since large format copy machines are available to the general public. Copying plans is tempting to a customer, but these copies would be worthless or void without the proof of purchase voucher. Copyright protection begins at the point of sale, and ends or is verified by the building official during the permit application.

Should any infringement still occur, legal protection can be sought, with the additional evidence of infringement provided by the proof of purchase system.

1) A method for buying home plans comprising: a seller providing the buyer with a proof of purchase voucher; the buyer or bearer of the home plans presenting proof of purchase voucher during building permit application proceedings; validity of home plans determined in part by expiration date of voucher.

2) The method according to claim 1, wherein the merchandise resembles a pre-drawn single-family home.

3) The method according to claim 1, wherein the merchandise resembles a pre-drawn multi-family structure, such as a duplex.

4) The method according to claim 1, wherein the merchandise resembles a pre-drawn home addition, such as a sun room.

5) The method according to claim 1, wherein the merchandise resembles a pre-drawn attached garage.

6) The method according to claim 1, wherein the merchandise resembles a pre-drawn detached garage.

7) The method according to claim 1, wherein the merchandise resembles a pre-drawn shed, storage unit, barn, or similar structure.

8) The method according to claim 1, wherein the proof of purchase voucher resembles a dated receipt.

9) The method according to claim 1, wherein the proof of purchase voucher resembles a certificate of authenticity.

10) The method according to claim 1, wherein the proof of purchase voucher resembles a ticket.

11) The method according to claim 1, wherein the proof of purchase voucher resembles electronically transferred proof of purchase.

12) A method of displaying home plans comprising: a display cabinet featuring an artist's rendering of the house positioned on a cabinet door which, when opened, reveals a supply of individually wrapped plans corresponding to the house displayed on the door.

13) A method of displaying home plans comprising: a leaf-through poster rack featuring an artist's rendering of the house within movable frames situated above a storage rack containing a supply of corresponding plans, referenced to displayed renderings above.

14) A method of providing printed home plans to a customer, using electronic means, such as a computerized selection system, and an attached printer.

15) The method according to claim 1, wherein the display is located within a specialty store.

16) The method according to claim 1, wherein the display is located within a retail outlet.

17) The method according to claim 1, wherein the display resembles a kiosk or booth.

18) The method according to claim 1, wherein the display resembles a mobile unit, such as a bookmobile.

19) The method according to claim 1, wherein the display resembles an automated vending device.
